(19) United States
(12) Patent Application Publication
(10) Pub. No.: US 2015/0148073 A1
(43) Pub. Date: May 28, 2015

(54) REDUCING SIGNALING LOAD CAUSED BY CHANGES IN TERMINAL LOCATION

(71) Applicants: Zhiwei Qu, Shanghai (CN); Yixin Chen, Shanghai (CN); Weiwei Jia, Shanghai (CN); Di Liu, Shanghai (CN); Zuogang Wang, Shanghai (CN); Meijuan Zheng, Shanghai (CN)

(72) Inventors: Zhiwei Qu, Shanghai (CN); Yixin Chen, Shanghai (CN); Weiwei Jia, Shanghai (CN); Di Liu, Shanghai (CN); Zuogang Wang, Shanghai (CN); Meijuan Zheng, Shanghai (CN)

(73) Assignee: Telefonaktiebolaget L M Ericsson (publ), Stockholm (SE)

(21) Appl. No.: 14/409,569

(22) PCT Filed: Jul. 10, 2012
(86) PCT No.: PCT/CN2012/078426

§ 371 Date: Dec. 19, 2014

(51) Int. Cl. H04W 28/02; H04W 60/04; H04W 64/00

(52) U.S. Cl. CPC H04W 28/0226; H04W 64/006; H04W 60/04; H04W 88/08
USPC 455/456.2; 455/456.1; 455/561

(57) ABSTRACT

This disclosure is directed to a serving node (220) and a method in a serving node (220) for reducing signalling caused by changes of location of a radio terminal (230), which serving node is configured to be operatively comprised by a wireless communication system (200), and to operatively handle payload data for the radio terminal, and to operatively communicate with a gateway node (210) acting as an interface between the system and an external network (250). The method comprises the actions of: obtaining initial position information indicating an initial position for the radio terminal; obtaining boundary information based on the initial position information, which boundary information indicates a boundary area wherein at least one of a policy or a charging rule is to be applied for the radio terminal; obtaining current position information indicating the current position of the radio terminal; determining whether the radio terminal is inside or outside the boundary area based on the boundary information and the position information; providing mobility information, indicating the current position of the radio terminal, to the gateway node when the radio terminal is outside the boundary area and not providing mobility information to the gateway node when the radio terminal is inside the boundary area.

### TECHNICAL FIELD

Exemplifying embodiments presented herein are directed towards a serving node, and corresponding method therein, for reducing signaling caused by changes in location of a radio terminal served by the node.

### BACKGROUND

Radio terminals in a wireless communications network communicate with one or more core networks via a Radio Access Network (RAN). The radio terminals may e.g. be mobile stations or user equipment units such as mobile telephones also known as “cellular” telephones, and laptops with wireless capability, e.g., mobile terminals, and thus can be, for example, portable, pocket, hand-held, computer-comprised, or car-mounted mobile devices which communicate voice and/or data with radio access network.

A radio access network covers a geographical area which is divided into cell areas, with each cell area being served by a radio access node, e.g. a Radio Base Station (RBS). In some radio access networks the radio access node may e.g. be called “NodeB” or “B node” or enhanced NodeB (eNB). A cell is a geographical area where radio coverage is provided by the equipment of a radio access node at a radio access node site. Each cell is identified by an identity, which may be broadcasted by the radio access node in within the local cell area. The radio access nodes communicate via an air interface with the radio terminals within range of the radio access nodes.

In some radio access networks, several radio access nodes are connected, e.g. by landlines or microwave links, to a Radio Network Controller (RNC) or a Base Station Controller (BSC) or similar, which supervises and coordinates various activities of the plural base stations connected thereto. A RNC or a BCS or similar are typically connected to one or more core networks.

In modern wireless communication systems there are typically Service Aware Charging and Control (SACC) components like an Online Charging System (OCS) and/or a Policy and Charging Rules Function (PCRF) that requires information about the location of the radio terminals in the system. The main purpose is to enable a differentiation of charging and policy depending on the location of a radio terminal.

For example, within General Packet Radio Service (GPRS) the Gateway GPRS Support Node (GGSN) may be configured to report changes in location of a radio terminal to a PCRF within the wireless communication system. The reporting GGSN may have obtain changes in location of a radio terminal from a Serving GPRS Support Node (SGSN), e.g. by requesting the Serving GPRS Support Node (SGSN) to report changes in location of a radio terminal.

The GGSN may request the SGSN to send such reports, even for each PDN connection independently. For example, the GGSN may use the “MS Info Change Reporting Action” parameter or similar for requesting the SGSN to report changes of CGI/SAI/RAI and/or use the “CSG Information Reporting Action” parameter or similar for requesting the SGSN to report changes of user CSG information to the GGSN.

However, this causes a heavy signalling load from the SGSN to the GGSN, and from the GGSN to the PCRF. Due to the increased signalling load it is recommended that a report of change in location is only applied for a limited number of radio terminals. However, even if a change in location is only reported for a limited number of terminals, the signalling load may still be too heavy.

### SUMMARY

In view of the above it seems that changes in location of radio terminals served by a wireless communication system causes heavy signalling load between nodes in the wireless communication system. Thus there seems to be a need for reducing such signalling load.

Embodiments of the present solution make location change simple and effective based on the notion that a gateway node—e.g. comprising a Policy and Charging Enforcement Function (PCEF)—and/or a SACC component can indicate a boundary of location that is of interested for a radio terminal. The serving node and/or the gateway node will not report any new locations to the gateway node or the SACC component respectively until the radio terminal moves out of the location area, whereupon a relevant SACC component or similar may apply a new charging rule or QoS policy or similar for the radio terminal in question.

At least some drawbacks indicated above have been eliminated or at least mitigated by an embodiment of the present solution directed to a method in a serving node for reducing signalling caused by changes of location of a radio terminal, which serving node is configured to be operatively comprised by a wireless communication system, and to operatively handle payload data for the radio terminal, and to operatively communicate with a gateway node acting as an interface between the system and an external network. The method comprises the actions of: obtaining initial position information indicating an initial position for the radio terminal; obtaining boundary information based on the initial position information, which boundary information indicates a boundary area wherein at least one of a policy or a charging rule is to be applied for the radio terminal; obtaining current position information indicating the current position of the radio terminal; determining whether the radio terminal is inside or outside the boundary area based on the boundary information and the position information; providing mobility information, indicating the current position of the radio terminal, to the gateway node when the radio terminal is outside the boundary area and not providing mobility information to the gateway node when the radio terminal is inside the boundary area.

At least some drawbacks indicated above have been eliminated or at least mitigated by an embodiment of the present solution directed to a serving node configured to be operatively comprised by a wireless communication system, and to handle payload data for a radio terminal, and to operatively communicate with a gateway node acting as an interface between the system and an external network. The serving node is further configured to operatively: obtain initial position information indicating an initial position for the radio terminal; obtain boundary information based on the initial position information, which boundary information indicates a boundary area wherein at least one of a policy or a charging rule is to be applied for the radio terminal; obtain current position information indicating the current position of the radio terminal; determine whether the radio terminal is inside or outside the boundary area based on the boundary information and the position information; provide mobility information, indicating the current position of the radio terminal, to the gateway node when the radio terminal is outside the boundary area, and not provide mobility information to the gateway node when the radio terminal is inside the boundary area to reduce signalling caused by change of location of the radio terminal.

### BRIEF DESCRIPTION OF THE DRAWINGS

The foregoing will be apparent from the following more particular description of exemplifying embodiments, as illustrated in the accompanying drawings in which like reference characters refer to the same parts throughout the different views. The drawings are not necessarily to scale, emphasis instead being placed upon illustrating the exemplifying embodiments.

FIG. 1 is a schematic illustration of an exemplifying wireless communication system 100 wherein at least some embodiments of the present solution can be implemented,

FIG. 2 is a schematic illustration of a more generalised exemplifying wireless communication system 200 wherein at least some embodiments of the present solution can be implemented,

FIG. 3 is a schematic illustration of a serving node according to at least some of the embodiments of the present solution;

FIG. 4a is a flow diagram illustrating exemplifying operations that may be executed by at least some embodiments of the present solution,

FIG. 4b illustrates a first exemplifying boundary area Aa and a second exemplifying boundary area Ab each defined by a separate sub-set of tracking areas in a set of tracking areas served by the system 200,

FIG. 5 is a signaling diagram illustrating exemplifying messages that may be exchanged between nodes in a wireless communication system configured to implement at least some embodiments of the present solution.

FIG. 6a is a signaling diagram illustrating exemplifying messages that may be exchanged between nodes in the wireless communication system 100 configured to implement at least some embodiments of the present solution.

FIG. 6b is a signaling diagram illustrating exemplifying messages that may be exchanged between nodes in the wireless communication system 100 configured to implement at least some embodiments of the present solution.

FIG. 6c is a signaling diagram illustrating exemplifying messages that may be exchanged between nodes in the wireless communication system 100 configured to implement at least some embodiments of the present solution.

FIG. 6d is a signaling diagram illustrating exemplifying messages that may be exchanged between nodes in the wireless communication system 100 configured to implement at least some embodiments of the present solution.

### DETAILED DESCRIPTION

In the following description, for purposes of explanation and not limitation, specific details are set forth, such as particular components, elements, techniques, etc. in order to provide a thorough understanding of some exemplifying embodiments of the present solution. However, it will be apparent to those skilled in the art that the exemplifying embodiments may be practiced in other manners that depart from these specific details.

In other instances, detailed descriptions of well-known methods and elements are omitted so as not to obscure the description of the exemplifying embodiments. The terminology used herein is for the purpose of describing the exemplifying embodiments and is not intended to limit the embodiments presented herein.

Exemplifying Wireless Communications Systems

The attention is now directed to the features of some exemplifying wireless communication systems wherein some embodiments of the present solution may be executed.

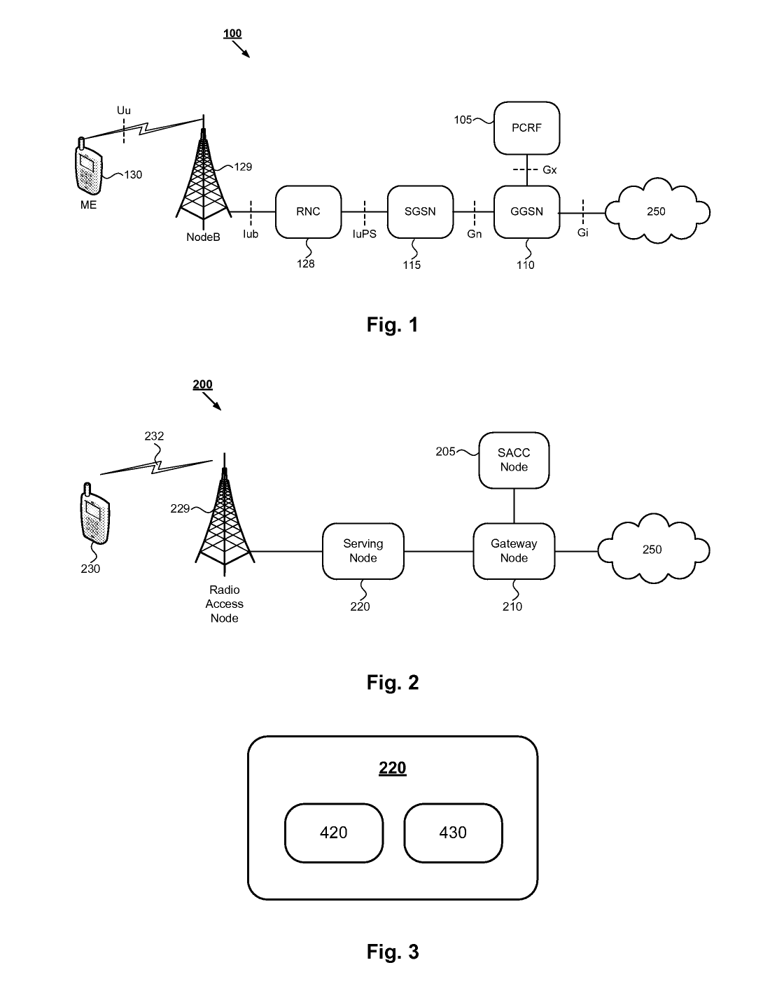

FIG. 1 shows a schematic overview of an exemplifying wireless communication system 100 in which some exemplifying embodiments presented herein may be utilised. The exemplifying system 100 is a so called General Packet Radio Service (GPRS) based system.

It should be appreciated that although FIG. 1 shows a GPRS based system, the example embodiments herein may also be utilised in other wireless communication systems comprising nodes and functions that correspond to the nodes and functions of the system 100.

System 100 may accommodate a plurality of various radio terminals, e.g. in the form of a plurality of mobile equipments or similar. FIG. 1 shows one Mobile Equipment (ME) 130 as an example. The radio terminals of system 100 or similar are configured to operatively communicate with one or several radio access nodes (e.g. a NodeB) of the system 100 using an air interface (e.g. an Uu) to access resources provided by the system 100. A skilled person having the benefit of this disclosure realizes that vast number of well known radio terminals may be used in connection with various embodiments of the present solution. The radio terminal may e.g. be a cell phone device or similar, e.g. such as a Mobile Station (MS) or a User Equipment (UE) or similar, e.g. defined by the standards provided by the 3GPP. The basic structure and functions of various radio terminals are well known to those skilled in the art and the basic structure and function of the radio terminals needs no detailed description as such. However, it should be emphasized that a radio terminal may be embedded (e.g. as a card or a circuit arrangement or similar) in and/or attached to various other devices, e.g. such as various laptop computers or tablets or similar or other mobile consumer electronics or similar, or vehicles or boats or air planes or other movable devices, e.g. intended for transport purposes. Indeed, the radio terminal may even be embedded in and/or attached to various stationary or semi-stationary devices, e.g. domestic appliances such as refrigerators or blenders or other kitchen appliances or similar, or consumer electronics such as printers or television sets or similar.

Traffic between the mobile equipment 130 and the core network of the exemplifying system 100 is routed via a radio access node, e.g. a base station, which, depending on the nature of the system, has different names. In a GPRS based system, such as the system 100, the radio access node may be referred to as a NodeB 129 (NB) or similar. The system 100 may comprise and/or be connected to a plurality of various radio access nodes, even other radio base stations that are not NodeB.

The mobility of the mobile equipment 130 is controlled by what may be generically referred to as a mobility management node. A mobility management node or similar is preferably configured to operatively control the mobility of the radio terminals of the system when moving between radio access nodes similar. This may e.g. include supervision and control of a handover of the radio terminal between two radio access nodes. The mobility management node may be a core network node in a core network of a wireless communication system or similar, or a radio access network node (RAN node) in a Radio Access Network (RAN) of a wireless communication system or similar. The specific mobility management node in the exemplifying system 100 is a Radio Network Controller (RNC) 128 configured to control a set of NodeBs. The RAN of system 100 may comprise a plurality of RNCs each controlling a set of NodeBs. The basic structure and functions of various mobility management nodes such as the RNC 128 are well known per se to those skilled in the art and the basic structure and function of the RNC 128 need no detailed description as such.

Moreover, system 100 also accommodates a Serving GPRS Support Node (SGSN) 115. It preferred that the SGSN 115 or similar of system 100 or similar is configured to operatively act as an interface between the internal IP network of the system 100 (mainly the core network) and the radio access network or similar (e.g. including NodeB:s and RNC:s as described above) of system 100 or similar. It is preferred that the SGSN 115 or similar of system 100 or similar is configured to operatively handle user plane data or similar payload data flowing between one or more radio terminals or similar—e.g. such as the mobile equipment 130 or similar—and the GGSN 110. This may e.g. at least include one of; tunneling of user plane data, establishing, modifying and/or releasing bearers etc for the mobile equipment or similar.

In addition, system 100 also accommodates a Gateway GPRS Support Node (GGSN) 110. It preferred that the GGSN 110 or similar of system 100 or similar is configured to operatively act as an interface between the internal IP network of the system 100 (mainly the core network) and external IP networks 250. This may e.g. include at least one of; allocation and/or reservation of IP addresses to user radio terminals currently registered in the system 100. This may also include that the PGW 110 or similar comprises a Policy and Charging Enforcement Function (PCEF) enforcing rules and/or policies or similar received from the PCRF 105 or a similar SACC component, and/or that the PGW is configured to act as a DHCP relay agent, comprising firewall functions and/or proxy functions and/or packet inspection functions etc. It may be added that the PGW 110 may be arranged to take certain policy and charging actions on its own without the use of a PCRF or similar.

Moreover, system 100 also accommodates a Policy and Charging Rules Function (PCRF) 105 or similar SACC component. It is preferred that the PCRF 105 or similar SACC component of system 100 or similar is configured to operatively determine policy rules—preferably in real-time—with respect to the radio terminals of the system 100 or similar. This may e.g. include at least one of; aggregating information to and from the core network and/or operational support systems of system 100 or similar so as to support the creation of rules and/or automatically making policy decisions for user radio terminals currently active in the system 100 based on such rules or similar. It is preferred that the PCRF 105 or similar is configured to provide the PGW 110 or similar with such rules and/or policies or similar to be used by the PGW 110 or similar acting as a PCEF or similar.

In system 100 the NodeB 129 is connected to the RNC 128, e.g. via an Iub interface, and the RNC 128 is connected to the SGSN 115, e.g. via an IuPS interface. In turn, the SGSN 115 is connected to the GGSN 110, e.g. via a Gn interface, and the GGSN 110 is connected to the PCRF 105, e.g. via a Gx interface. The interfaces Uu, Iub, IuPS, Gn, Gx and Gi shown in FIG. 1 or similar are all well known to those skilled in the art. Moreover, these interfaces and similar are thoroughly defined in the 3GPP specifications and they need no detailed description as such.

FIG. 2 shows a schematic overview of an exemplifying wireless communication system 200, which may be regarded as a generalisation of the exemplifying wireless communication system 100 shown in FIG. 1. System 200, in which the exemplifying embodiments presented herein may be utilised, comprises one or more radio access nodes 229, at least one serving node 220, at least one gateway node 210 and at least one Service Aware Charging and Control (SACC) component node.

Before proceeding it should be emphasised that embodiments of the solution—including the embodiments presented herein—may be implemented in other wireless communication systems than systems 100 and 200 discussed herein.

The exemplifying radio access nodes 229 may be any suitable radio access node that is configured to route traffic between one ore more radio terminals 230 and the core network of system 200. The core network may at least comprise the serving node 220, the gateway node 210 and the SACC node 205. The radio access node may e.g. be a base station, e.g. a NodeB 129 or similar as in system 100.

The exemplifying radio terminal 230 may be any suitable radio terminal configured to operatively communicate with the radio access node 229 via an air interface 232. The radio terminal 229 may e.g. be a Mobile Equipment or a User Equipment or a Mobile Station or similar as described above with reference to system 100.

The serving node 220 may be any serving node configured to operatively act as an interface between the internal IP network (mainly the core network) and the radio access network or similar of system 200, e.g. including the radio access node 229 and possible radio network controllers, e.g. such as the RNC 128 or similar. It is preferred that the serving node 115 or similar of system 100 or similar is configured to operatively handle user plane data or similar payload data flowing between one or more radio terminals or similar—e.g. such as the mobile equipment 130 or similar—and the gateway nose 210. This may e.g. at least include one of; tunneling of user plane data, establishing, modifying and/or releasing bearers etc for the mobile equipment or similar. The mobility management node 220 may e.g. be a core network node, e.g. a SGSN 120 or similar as described above with reference to system 100, or a Serving Gateway (SGW) or similar.

The gateway node 210 may be any suitable gateway node configured to operatively act as an interface between the internal IP network of the system 200—mainly the core 15 network—and external IP networks 250. The gateway node 210 may e.g. be a GGSN 120 or similar, or a PDN Gateway (PGW).

The SACC node 205 may be any suitable node that comprises a SACC function or similar. The SACC node 205 may e.g. be configured to operatively provide an Online Charging System (OCS) and/or a Policy and Charging Rules Function (PCRF), configured to enable a differentiation of the charging and/or policy depending on the location of a radio terminal 230.

FIG. 3 shows some interior parts of the serving node 220 being relevant to the example embodiments described herein. As can be seen, the serving node 220 may comprise processing circuitry 420 and a memory unit 430. The processing circuitry 420 may e.g. comprise signal processing circuitry and/or logic circuitry and/or interfacing circuitry as required by the embodiments described herein. In particular embodiments, some or all of the functionality described herein as being provided by a serving node or similar may be provided by the processing circuitry 420, e.g. executing instructions stored on a computer-readable medium, such as the memory unit 430 shown in FIG. 3. Alternative embodiments of the serving node 220 may comprise additional components responsible for providing additional functionality, comprising any of the functionality identified herein and/or any functionality necessary to support the example embodiments described herein.

Operation of Exemplifying Communications Systems

The attention is now directed to the operation of wireless communication systems wherein some embodiments of the present solution may be executed.

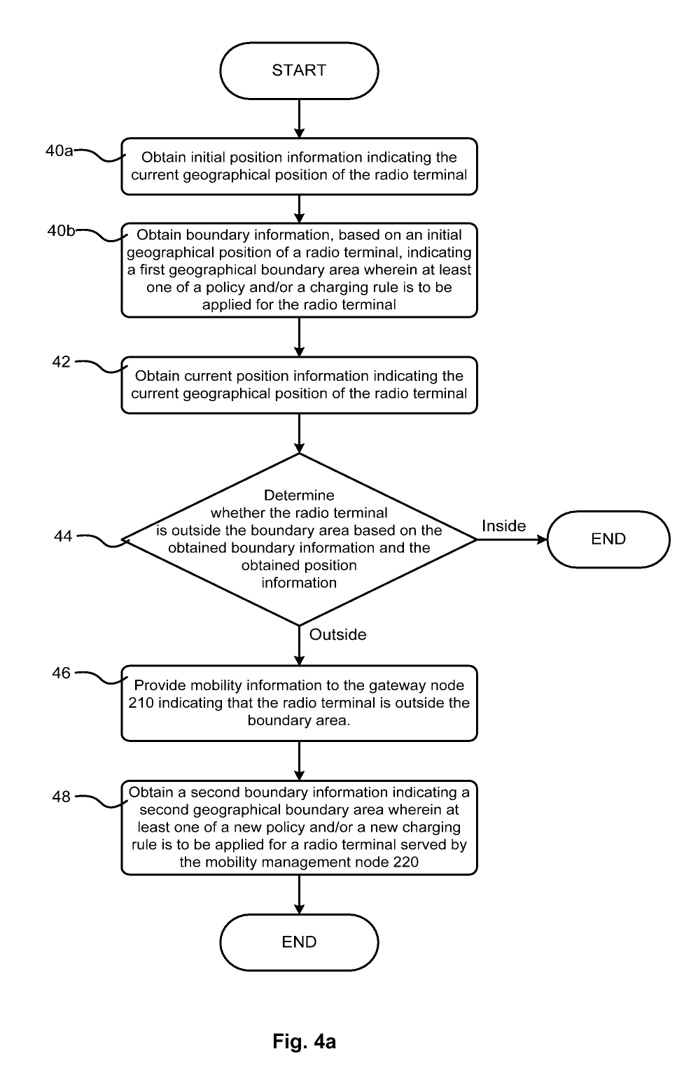

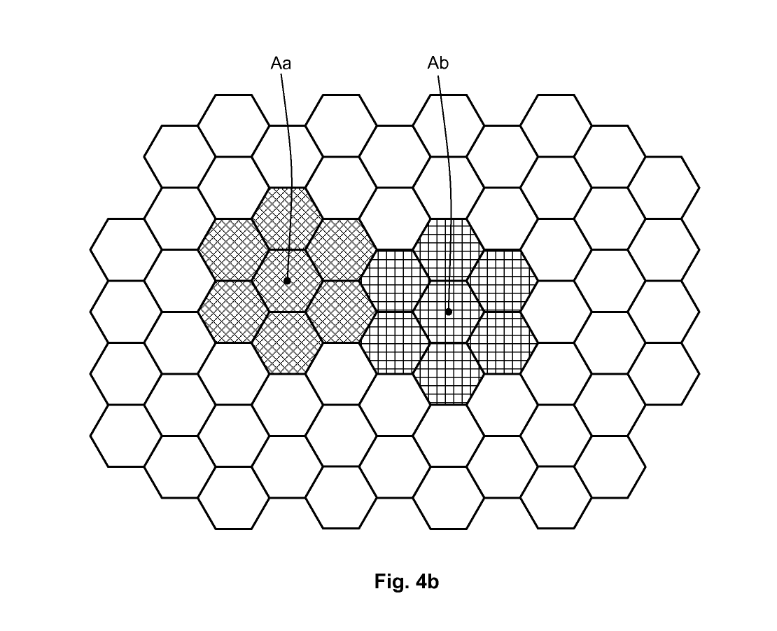

FIG. 4a illustrates a flow diagram depicting exemplifying operations which may be performed by the serving node 120 and 220 of FIG. 1 and FIG. 2 respectively so as to provide a reduced signalling load between the core nodes of the wireless communication system 100 or 200 respectively, which signalling load is caused by a change in location of the radio terminals served by the system.

Example Operation 40a:

The serving node 220 may be configured to operatively obtain initial position information indicating an initial geographical position of the radio terminal 230.

The initial geographical position is not necessarily the first position that the radio terminal has ever had. Rather, the initial geographical position is the position held by the radio terminal 230 when operation 40b starts, meaning that the radio terminal 230 may or may not have held other positions before operation 40b starts.

The initial position information indicating the initial geographical position of the radio terminal may be any information from which the serving node 220 can construe the initial position of the radio terminal 230. The information may e.g. represent the initial geographical coordinates of the radio terminal 230, e.g. originally obtained by means of a GPS-function in the radio terminal 230 and/or by means of a triangulation function implemented in one or several nodes of the system 200, e.g. utilising a plurality of radio access nodes 229 that receive radio signals from the terminal 230. Additionally or alternatively, the initial geographical position may e.g. be represented by the identity of a TA and/or a LA and/or RA or a similar area, or even by the identity of a PLMN, or by the identity of one or several RAN nodes, e.g. the identity of one or several radio access 30 nodes, e.g. such as the radio access node 229 or similar, or one or several cells served by such a radio access node.

The serving node 220 may be configured to obtain the initial position information—indicating an initial geographical position of the radio terminal 230—by requesting and/or 35 receiving such information from the radio terminal 230 and/or from a RAN node or similar currently serving the radio terminal 230, e.g. such as the radio access node 229 and/or the RNC 128. Additionally or alternatively the serving node 220 may be configured to obtain the initial position information by requesting and/or receiving such information from one or more core network nodes of a wireless communication system in which the mobility management node operates, e.g. one or more core network nodes of system 200 or similar. The request and/or reception may be performed via one or more other nodes or similar of the system 200.

Example Operation 40b:

The serving node 220 may be configured to operatively obtain boundary information based on the initial geographical position of the radio terminal 230, which boundary information indicates a geographical boundary area wherein a policy and/or a charging rule or similar is to be operatively applied for the radio terminal 230.

The serving node 220 may obtain the boundary information by requesting and/or receiving boundary information from a node of the system 200, e.g. from a node in the core network of the system 200, e.g. from the gateway node 210 and/or from the SACC node 205 or similar. The request and/or reception may be performed via one or more other nodes or similar of the system 200. For example, the request and/or reception may pass one or more other nodes before arriving at the target. Additionally or alternatively, the serving node 220 may obtain boundary information in that the boundary information is pre-configured in the serving node 220. For example, the boundary information may have been previously requested and/or received from a node in system 200, e.g. from a node in the core network of system 200. The serving node 220 may initiate an obtaining of boundary information, e.g. by providing the geographical position of the radio terminal 230 in a request sent to a node in the core network of the system 200, e.g. to the gateway node 210 and/or the SACC node 205 or similar. In addition or alternatively, the gateway node 210 and/or the SACC node 205 may initiate the obtaining of boundary information, e.g. by sending a request to the serving node 220. The request may be performed via one or more other nodes or similar of the system 200, e.g. the request may pass one or more other nodes before arriving at the serving node 220.

A geographical boundary area may e.g. be defined by one or more Tracking Areas (TA) and/or Location Areas (LA) and/or Routing Areas (RA) or similar areas, or even a by a Public Land Mobile Network (PLMN) or similar. Note that a TA, a LA and a RA or similar area may comprise one or several RAN nodes. Indeed the geographical area may correspond to the coverage of one or several RAN nodes, e.g. the coverage of the cell or cells served by one or several radio access nodes, e.g. such as the radio access node 229 or similar.

FIG. 4b illustrates a first exemplifying boundary area Aa (see the hexagons with horizontal stripes) comprising a first sub-set of Tracking Areas (TA:s) in a set of TA:s served by the system 200, and a second exemplifying boundary area Ab (see the hexagons with vertical stripes) comprising a second sub-set of TA:s in the set of TA:s served by the system 200. Here, it is assumed that the first boundary area and the second boundary area are adjacent to each other. Other boundary areas may neither be adjacent to the first boundary area Aa nor to the second boundary area Ab but they may still be relevant for the present solution.

A policy for a radio terminal may e.g. indicate one or more services or similar that the radio terminal is allowed to access and/or use, and/or the conditions or similar under which such services can be accessed and/or used. This may e.g. include an indication of the level of service and/or the Quality of Service (QoS) or similar to be provided for one or more services used by the radio terminal in question. Additionally or alternatively a policy may indicate a routing scheme and/or a security scheme or similar to be applied with respect to the radio terminal in question, e.g. in terms of encoding schemes and/or firewall functions and/or packet filtering functions or similar to be applied with respect to the terminal. Said one or more services may be provided by the core network or via the core network of the system 200. The character and/or function of various policies are well known to those skilled in the art and they need no detailed description as such.

A charging rule may e.g. indicate features to be applied with respect to billing schemes or similar for the radio terminal in question. The billing schemes or similar relate to the usage of services accessed and/or used by the radio terminal 230. The character and/or function of various charging rules are well known to those skilled in the art and they need no detailed description as such.

Some embodiments of the present solution may define and/or store all or parts of the policy and/or charging rules or similar for a radio terminal in a subscriber database or similar. The subscriber database may be provided by a node in or a function in the core network of the system 200. The subscriber database may e.g. be provided by a SACC node, e.g. by a Home Subscriber Server (HSS) or similar. The policy and/or charging rules elaborated herein may at least partly be the same or similar as those used in connection with GPRS based systems or similar defined in the 3GPP specifications.

Example Operation 42:

The serving node 220 may be configured to operatively obtain position information indicating the current geographical position of the radio terminal 230.

The position information indicating of the current geographical position of the radio terminal may be any information from which the serving node 220 may deduce the current geographical position of the radio terminal 230. The information may e.g. represent the current geographical coordinates of the radio terminal 230, e.g. originally obtained by means of a GPS-function in the radio terminal 230 and/or by means of a triangulation function implemented in one or several nodes of the system 200, e.g. utilising a plurality of radio access nodes 229 that receive radio signals from the terminal 230. Additionally or alternatively, the current geographical position may be represented by the same or similar information that may represent the geographical boundary area. In other words the current position may e.g. be represented by the identity of a TA and/or a LA and/or RA or a similar area, or even by the identity of a PLMN, or by the identity of one or several RAN nodes, e.g. the identity of one or several radio access nodes, e.g. such as the radio access node 229 or similar, or one or several cells served by such a radio access node.

The serving node 220 may be configured to obtain the position information indicating a current geographical position of the radio terminal 230 by requesting and/or receiving such information from the radio terminal 230 and/or from a RAN node or similar currently serving the radio terminal 230, e.g. such as the radio access node 229. Additionally or alternatively the serving node 220 may be configured to obtain the position information indicating the current geographical position of the radio terminal 230 by requesting and/or receiving such information from one or more core network nodes of a wireless communication system in which the serving node operates, e.g. one or more core network nodes in the system 200 or similar. The request and/or reception may be performed via one or more other nodes or similar of the system 200.

Example Operation 44:

The serving node 220 may be configured to operatively determine whether the radio terminal 230 is currently outside the geographical boundary area, based on the boundary information obtained in operation 40 and based on the position information obtained in operation 42. If the radio terminal 230 is outside the boundary area then the execution will proceed to operation 46 wherein the current position is reported as will be described below. However, if the radio terminal 230 is still inside the boundary area then the execution is ended and the current geographical position of the radio terminal 230 is not reported according to operation 46, which will reduce the overall signaling load in the core network of system 200.

For example, the serving node 220 may determine that the radio terminal 230 is currently outside the boundary area by comparing the boundary information with the position information. For example, it can be determined that the radio terminal 230 is outside the boundary area when the position information indicates a current geographical position for the radio terminal 230 that is outside or at least substantially outside the geographical boundary area indicated by the boundary information.

For example, if the boundary information and the position information indicate the same TA, or LA or RA or similar then the boundary area and the current geographical position coincide and the radio terminal is within the boundary area. However, if the boundary information and the position information indicate different TA:s, or LA:s or RA:s or similar then the radio terminal is outside the boundary area. In another example, if the if the boundary information indicates a TA, LA or RA or similar whereas the position information indicates a cell that is outside the TA, LA or RA in question then the radio terminal is outside the boundary area. In still another example, if the if the boundary information indicates a PLMN or similar whereas the position information indicates a TA, LA, RA or a cell or similar that is outside the coverage of that PLMN then the radio terminal is outside the boundary area.

Example Operation 46:

The serving node 220 may be configured to operatively provide mobility information to the gateway node 210 indicating that the radio terminal 230 is outside the boundary area.

The mobility information may e.g. indicate the current position of the radio terminal 230. Additionally or alternatively, the mobility information may simply indicate that the radio terminal 320 has a current position that differs from a previous position, i.e. indicate that the position of the radio terminal 230 has changed. Here the gateway node 210 may request further information indicating the current position of the radio terminal from the serving node 220, which in turn may reply by sending such information to the gateway node 210.

The serving node 220 may be configured to provide mobility information—indicating the current geographical position of the radio terminal 230—by sending such information to the gateway node 210, e.g. by sending a message comprising the mobility information to the gateway node 210. The information may be sent via one or more other nodes or similar of the system 200.

As already indicated when discussing operation 44 above it is preferred that the serving node 220 is configured to operatively provide mobility information to the gateway node 210 area only when it is detect that the radio terminal 230 is outside the geographical boundary area. Thus, no mobility information is sent from the serving node 220 to the gateway node 210 while the radio terminal changes 230 its position within the boundary area. This has the advantage of reducing the signaling load between the serving node 220 and the gateway node 210 since no mobility information is provided unless the radio terminal 230 appears outside the boundary area. As an additional effect the signaling load between the gateway node 210 and the SACC node 205 of system 200 is also reduced since the gateway node 210 will not report any changed position for the radio terminal 230 until the gateway node 210 receives mobility information from the serving node 220 as indicated above. Thus, the total signaling load within system 200 is significantly reduced.

Example Operation 48:

The serving node 220 may be configured to operatively obtain another boundary information indicating another boundary area wherein another policy and/or another charging rule is to be operatively applied for the radio terminal 230. Obtaining another boundary information is a result of the fact that the position of the radio terminal 230 is outside the first boundary area indicated by the first boundary information obtained in operation 40b discussed above and thus a new policy and/or charging rule is to be operatively applied for the radio terminal 230.

The serving node 220 may obtain the second boundary information in the same or similar manner as the first boundary information is obtained in operation 40b discussed above, e.g. by requesting and/or receiving the boundary information from the gateway node 120 and/or the SACC node 205 or similar of the system 200.

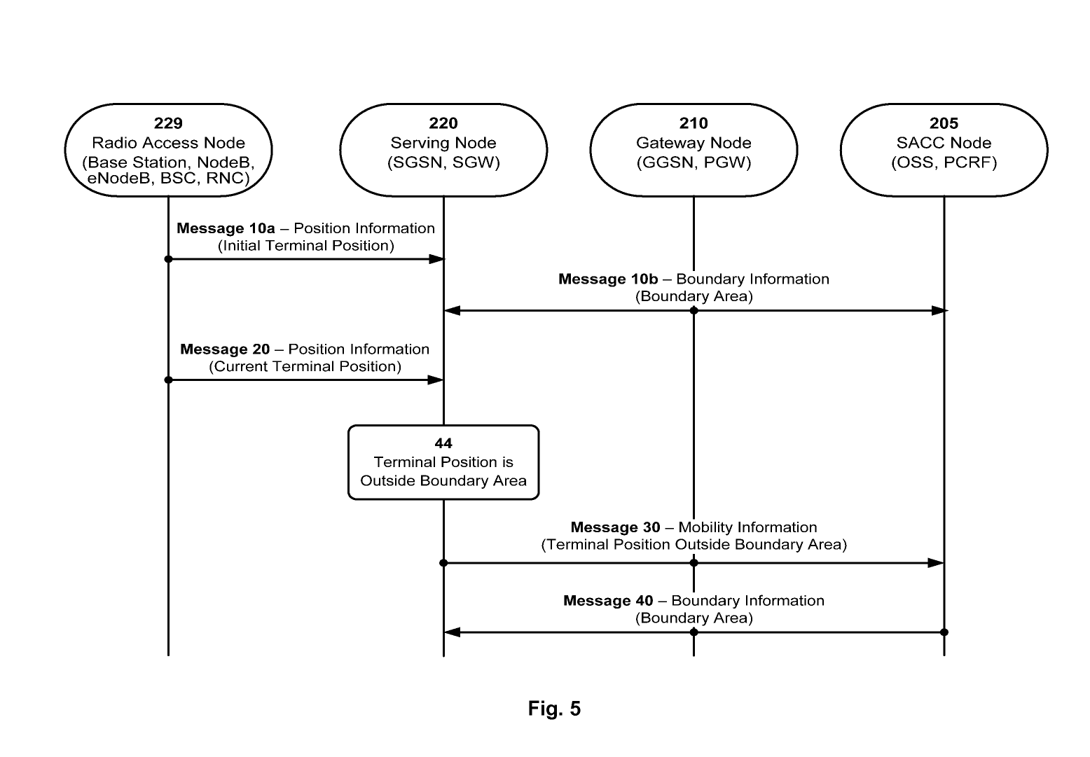

FIG. 5 is a signaling diagram illustrating some exemplifying messages that may be transmitted and/or received by nodes implementing at least some embodiments of the present solution.

FIG. 5 shows a radio access node 229, a serving node 220, a gateway node 210 and a SACC node 205 as previously discussed above with reference to system 200 shown in FIG. 2. As indicated when discussing system 200, the radio access node 229 may e.g. be a base station, e.g. such as a NodeB or an eNodeB or similar, and the serving node 220 may be a SGSN or a SGW or similar, and the gateway node 210 may e.g. be a GGSN or a PGW, and the SACC node 205 may e.g. be an OSS or a PCRF or similar.

The signalling diagram of FIG. 5 illustrates various action performed by the nodes 220, 210, 205 and messages sent between the nodes 220, 210, 205 as will be elaborated in some detail below. However, it should be appreciated that the messages and actions elaborated below are a non-limiting examples. Some embodiments of the present solution may comprise additional messages and some other embodiments may not use all the messages indicated below. Some other embodiments may perform the messages in a different order compared to the one given in FIG. 5.

Message 10a:

The serving node 220 may be configured to operatively receive position information in a message 10a sent from the radio access node 229. The reception may be performed via one or more other nodes or similar of the system 200. The radio access node 229 may have initiated this message. Alternatively, the serving node 220 may have initiated this message by requesting the position information from the radio access node 229, which in turn may reply by sending such information to the serving node 220.

Message 10a is one way of performing operation 40a discussed above with reference to FIG. 4a.

Message 10b:

The serving node 220 may be configured to operatively receive boundary information in a message 10b sent from the gateway node 210 to the serving node 220. The reception of the boundary information in the serving node 220 may be performed via one or more other nodes or similar of the system 200. For example, the gateway node 210 may have received the boundary information or similar in a message sent from the SACC node 205 before the gateway node 210 sends the boundary information to the serving node 220. The SACC node 205 and/or the gateway node 210 may have initiated this message. Alternatively, the serving node 220 may have initiated this message, e.g. by requesting boundary information from the gateway node 210 and/or the SACC node 205, which in turn may reply by sending such information to the serving node 220.

Message 10b is one way of performing operation 40b discussed above with reference to FIG. 4a.

Message 20:

The serving node 220 may be configured to operatively receive position information in a message 20 sent from the radio access node 229. The reception may be performed via one or more other nodes or similar of the system 200. The radio access node 229 may have initiated this message. Alternatively, the serving node 220 may have initiated this message, e.g. by requesting the position information from the radio access node 229, which in turn may reply by sending such information to the serving node 220.

Message 20 is one way of performing operation 42 discussed above with reference to FIG. 4a.

Message 30:

Here it is assumed that operation 44 has been performed, as discussed above with reference to FIG. 4. Thus, here it may be assumed that the serving node 220 has determined that that radio terminal 230 is outside the boundary area based on the boundary information obtained in message 10b and based on the position information obtained in message 20 as described above.

When it is determined that that radio terminal 230 is outside the boundary area then the serving node 220 may be configured to operatively send a message 30 comprising mobility information to the gateway node 210, where the mobility information indicates that the radio terminal 230 is outside the boundary area. The mobility information may e.g. indicate the current position of the radio terminal 230 and/or indicate that the radio terminal 320 has a current position that differs from a previous position, i.e. indicate that the position of the radio terminal 230 has changed.

In turn, the gateway node 210 may send the mobility information in a message to the SACC node 205 or similar.

Message 30 is one way of performing operation 46 discussed above with reference to FIG. 4a.

Message 40:

The serving node 220 may be configured to operatively obtain another boundary information as discussed above in connection with operation 48 in FIG. 4a.

The serving node 220 may obtain the other boundary information in the same or similar manner as describe above when discussing message 10b.

Message 40 is one way of performing operation 48 discussed above with reference to FIG. 4a.

The attention is now directed to a number of exemplifying embodiments that will be described with reference to a GPRS based system such as system 100 discussed above with reference to FIG. 1. The embodiments relate i.a. to the specifications 3GPP TS 23.060 and/or 3GPP TS 29.060.

Before proceeding it should be emphasised that some embodiments of the present solution—not limited to embodiments implemented in system 100—may utilise Boundary Information that comprises a list of Tracking Area Identifiers (TAIs) and/or Routing Area Identifiers (RAIs) and/or a list of Cell Global Identifiers (CGIs) and/or Service Area Identifiers (SAIs) and/or EUTRAN Cell Global Identifiers (ECGIs).

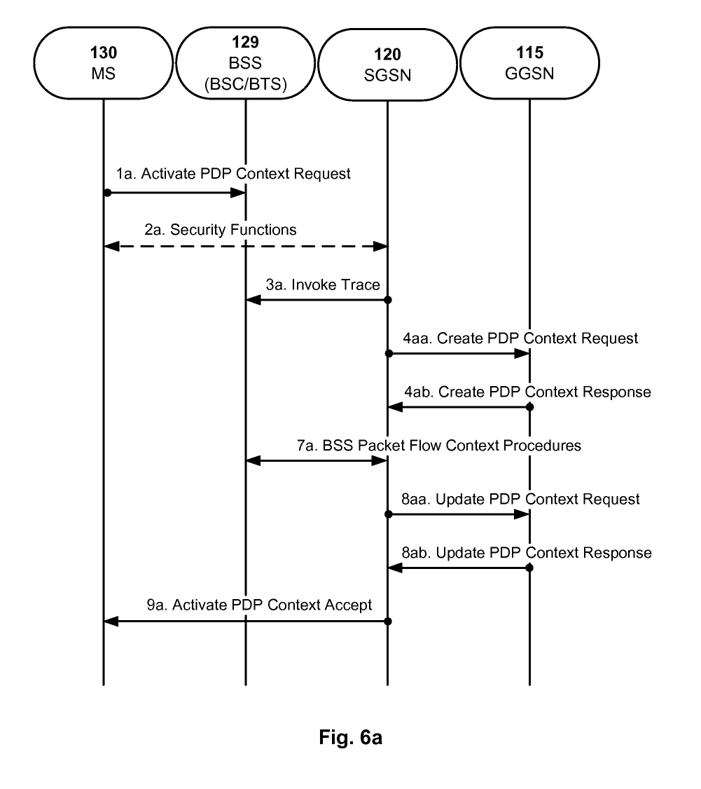

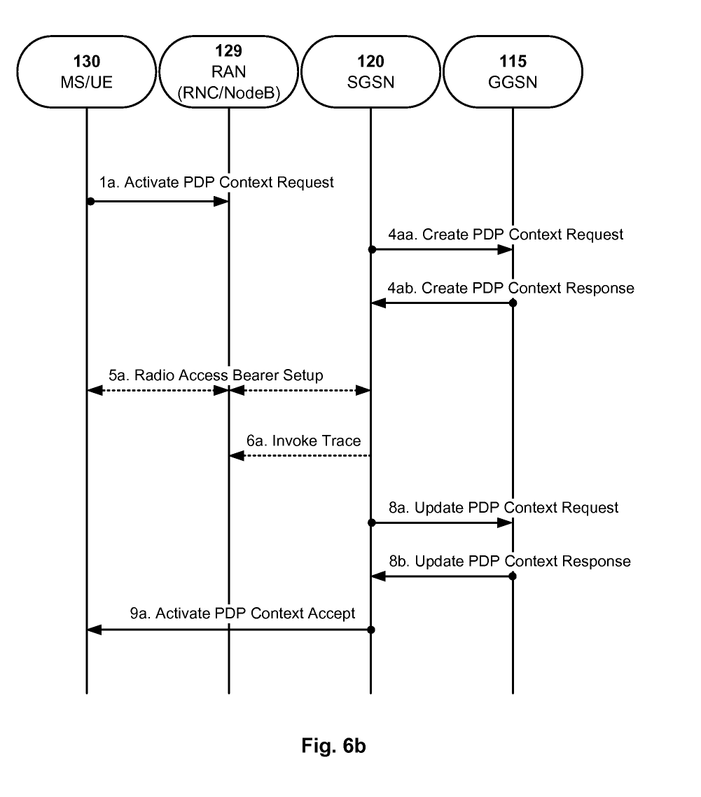

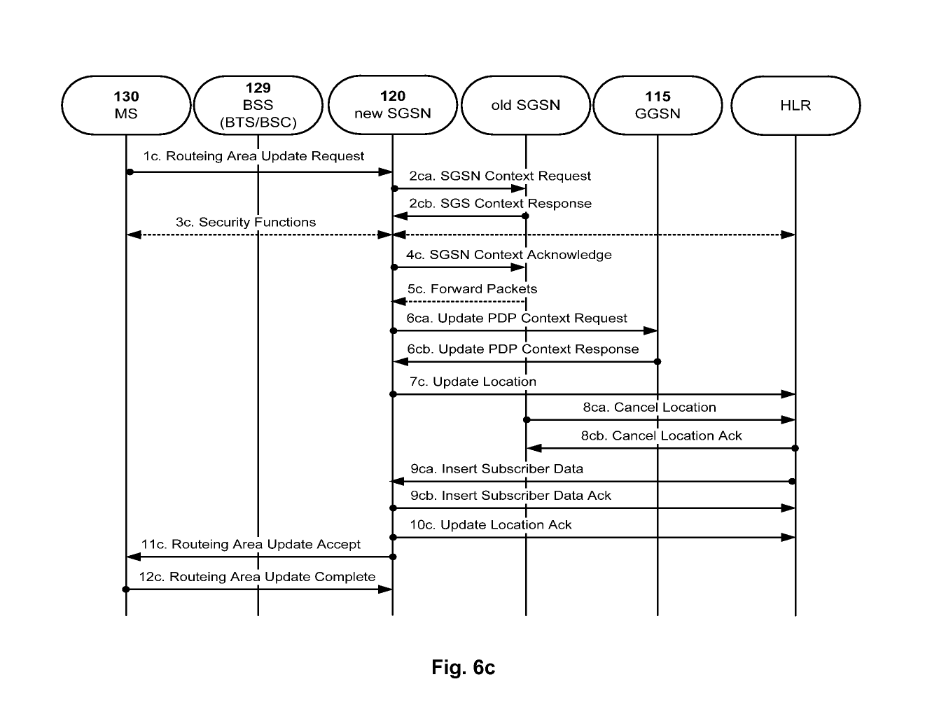

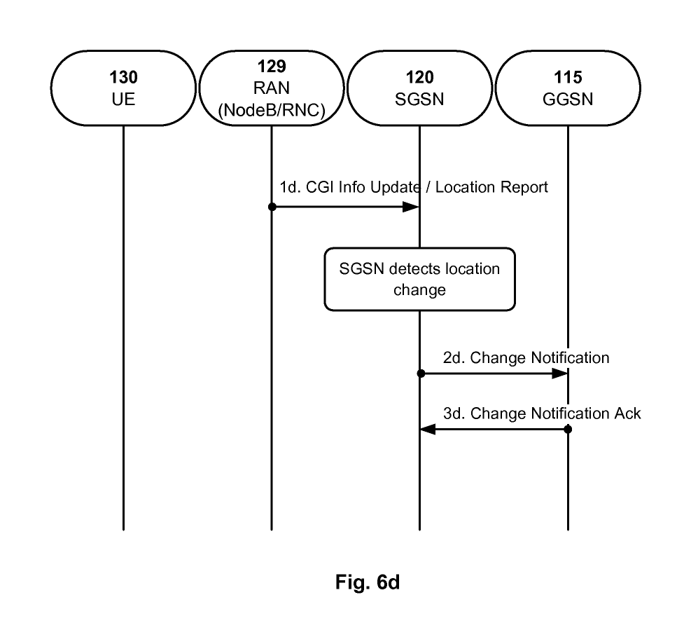

FIG. 6a is a signaling diagram illustrating exemplifying messages that may be transmitted and/or received by nodes implementing at least some embodiments of the present solution in connection with a PDP Context Procedure for A/Gb mode.

FIG. 6a shows the MS 130, a Base Station Subsystem (BSS) e.g. comprising an Base Station Controller (BSC) and at least one Base Transceiver Station (BTS), the SGSN 120, and the GGSN 115 as previously describe for example with reference to FIG. 1.

FIG. 6b is a signaling diagram illustrating exemplifying messages that may be transmitted and/or received by nodes implementing at least some embodiments of the present solution in connection with a PDP Activation Procedure for Iu mode.

FIG. 6b shows the MS 130 (which in this case may be an UE), a Radio Access Network (RAN) e.g. comprising a Radio Network Controller (RNC) and at least one NodeB, the SGSN 120, and the GGSN 115 as previously describe for example with reference to FIG. 1.

The signalling diagram of FIG. 6a and FIG. 6b illustrate various action performed by and messages sent between the nodes 130, 129, 120 and 115 as will be elaborated in some detail below.

Message 1a: The MS 130 may send an Activate PDP Context Request (e.g. NSAPI, TI, PDP Type, PDP Address, Access Point Name, QoS Requested, Protocol Configuration Options, Request Type) message to the SGSN 120.

Message 2a: In A/Gb mode, security functions may be executed.

Message 3a: In A/Gb mode and if BSS trace is activated, the SGSN 120 shall send an Invoke Trace (e.g. Trace Reference, Trace Type, Trigger Id, OMC Identity) message to the BSS, e.g. comprising the RNC 128 and the ME 130 as indicated above with reference to FIG. 1.

Message 4aa: The SGSN 120 sends a Create PDP Context Request (e.g. PDP Type, PDP Address, Access Point Name, QoS Negotiated, Negotiated Evolved ARP, TEID, NSAPI, MSISDN, Selection Mode, Charging Characteristics, Trace Reference, Trace Type, Trigger Id, OMC Identity, Protocol Configuration Options, serving network identity, Maximum APN Restriction IMEISV, CGI/SAI, User CSG Information, RAT type, S-CDR CAMEL information, MS Info Change Reporting support indication, NRSN, Dual Address Bearer Flag, APN-AMBR, max MBR/APN-AMBR) message to the affected GGSN 115.

Here, there may be no Boundary Information defined for the MS 130. The SGSN 120 may report the initial MS location (CGI+TAI) and/or indicate the initial TAI list for the MS 130 to the GGSN 115.

Message 4ab: The GGSN 115 may send a Create PDP Context Response message to the SGSN 120. It is preferred that the GGSN 115 provides Boundary Information fitting for the location for the MS 130. Alternatively, a current TAI list suggested by the SGSN 120 may be used as Boundary Information if no Boundary Information is returned by the GGSN 115.

The GGSN 115 may e.g. have stored Boundary information locally and/or requested the Boundary Information from a SACC component such as a PCRF 105 or similar, e.g. by sending a request message comprising the current location of the MS 130 to the SACC component.

Since the SGSN 120 has now been provided with the Boundary Information it can limit the report to the GGSN 115 of any change in the location of the MS 130 to situations where the MS 130 has moved outside the boundary area indicated by the Boundary Information. This has the advantage of reducing the signaling load between the SGSN 120 and the GGSN 115 and also between the GGSN 115 and a possible SACC component such as the PCRF 105, since no mobility information is provided by the SGSN 120 unless the MS 130 appears outside the boundary area. In other words, no mobility information is provided by the SGSN 120 as long as the MS 130 moves within the boundary area.

Message 5a: In Iu mode, RAB setup is done by the RAB Assignment procedure.

Message 6a: In Iu mode and if BSS trace is activated, the SGSN 120 may send an Invoke Trace (e.g. Trace Reference, Trace Type, Trigger Id, OMC Identity) message to the RAN, e.g. comprising a Radio Network Controller (RNC) and at least one NodeB.

Message 7a: The In A/Gb mode, BSS packet flow context procedures may be executed.

Messages 8aa and 8ab: In case the QoS attributes, used in connection with message 5a for Iu mode or message 7a for A/Gb mode, have been downgraded during those steps, the SGSN 120 may inform the GGSN 115 about the downgraded QoS attributes by sending an Update PDP Context Request to the affected GGSN 115. The GGSN 115 then returns a Create PDP Context Response (e.g. TEID, PDP Type, PDP Address, Protocol Configuration Options, QoS Negotiated, Negotiated Evolved ARP, Charging Id, Prohibit Payload Compression, APN Restriction, Cause, MS Info Change Reporting Action, CSG Information Reporting Action, BCM, APN-AMBR) message to the SGSN 120.

Message 9a: The SGSN 120 returns an Activate PDP Context Accept (e.g. PDP Type, PDP Address, TI, QoS Negotiated, Radio Priority, Packet Flow Id, Protocol Configuration Options) message to the MS 130.

Message 4aa indicated above may be seen as one way of requesting the Boundary Information as indicated in operation 40b discussed above with reference to FIG. 4a. The request may be seen as initiated by the SGSN 120 sending a message to the GGSN 115. Note that the geographical position of the MS 130 is provided in the request sent by the SGSN 120, c.f. for example the CGI/SAI mentioned above.

Message 4ab indicated above may be seen as one way of receiving the Boundary Information as indicated in operation 40 discussed above with reference to FIG. 4a. The receiving may be seen as initiated by the SGSN 120 sending a message comprising the position of the MS 130 to the GGSN 115, c.f. message 4aa.

FIG. 6c is a signaling diagram illustrating other exemplifying messages that may be transmitted and/or received by nodes implementing at least some embodiments of the present solution in connection with an Inter SGSN Routeing Area Update Procedure.

FIG. 6c shows the MS 130, the BSS mentioned above with reference to FIGS. 6a and 6b, the SGSN 120, the GGSN 115 as previously describe for example with reference to FIG. 1. In addition, FIG. 6c shows a Home Location Register (HLR) and an old SGSN.

The signalling diagram of FIG. 6c illustrates various action performed by and messages sent between the nodes 130, 129, 120 and 115 as will be elaborated in some detail below.

Message 1c: The MS 130 sends a Routeing Area Update Request (e.g. old RAI, old P-TMSI Signature, Update Type, MS Radio Access Capability, DRX parameters, MS

Network Capability, additional P-TMSI/RAI, Voice domain preference and UE's usage setting) message to the new SGSN 120.

Message 2c: The new SGSN 120 sends SGSN Context Request (old RAI, TLLI, old P-TMSI Signature, New SGSN Address) message to the old SGSN to get the MM and PDP contexts for the MS 130.

Message 3c: Security functions may be executed.

Message 4c: The new SGSN 120 sends an SGSN Context Acknowledge message to the old SGSN.

Message 5c: Only old Gn/Gp SGSNs may forward data in a message to a new SGSN 120.

Message 6ca: The new SGSN 120 sends Update PDP Context Request (e.g. new SGSN Address, TEID, QoS Negotiated, Negotiated Evolved ARP, serving network identity, CGI/SAI, User CSG Information, RAT type, MS Info Change Reporting support indication, NRSN) to the GGSN 115.

Here, there may be no Boundary Information defined for the MS 130. The SGSN 120 may report the initial MS location (CGI+TAI) and/or indicate the initial TAI list for the MS 130 to the GGSN 115.

Message 6cb: The GGSN 115 may update its PDP context fields and return an Update PDP Context Response (e.g. TEID, Prohibit Payload Compression, APN Restriction, MS Info Change Reporting Action, CSG Information Reporting Action, BCM, Negotiated Evolved ARP) message to the SGSN 120. It is preferred that the GGSN 115 provides Boundary Information fitting for the location for the MS 130. Alternatively, a current TAI list suggested by the SGSN 120 may be used as Boundary Information if no Boundary Information is returned by the GGSN 115.

Message 7c: The new SGSN 120 informs the HLR of the change of SGSN by sending an Update Location (e.g. SGSN Number, SGSN Address, IMSI, IMEISV, UE SRVCC capability) message to the HLR.

Message 8c: The HLR sends a Cancel Location (e.g. IMSI, Cancellation Type) to the old SGSN with Cancellation Type set to Update Procedure.

Message 9ca: The HLR sends an Insert Subscriber Data (e.g. IMSI, Subscription Data) message to the new SGSN 120.

Message 9cb: The new SGSN 120 sends an acknowledge message to the HLR.

Message 10c: The HLR acknowledges the Update Location by sending an Update Location Ack (e.g. IMSI, GPRS Subscriber Data (only if S6d interface is used)) message to the new SGSN 120.

Message 11c: The new SGSN 120 responds to the MS 130 with a Routeing Area Update

Accept message (e.g. P-TMSI, P-TMSI Signature, Receive N-PDU Number, IMS voice over PS Session Supported Indication).

Message 12c: The MS 130 acknowledges the new P-TMSI by returning a Routeing Area Update Complete (Receive N-PDU Number) message to the SGSN 120.

Message 6ca indicated above may be seen as one way of requesting the Boundary Information as indicated in operation 40b discussed above with reference to FIG. 4a. The request may be seen as initiated by the new SGSN 120 sending a message to the GGSN 115. Note that the geographical position of the MS 130 is provided in the request sent by the MME 120, c.f. for example the CGI/SAI mentioned above.

Message 6cb indicated above may be seen as one way of receiving the Boundary Information as indicated in operation 40 discussed above with reference to FIG. 4a. The receiving may be seen as initiated by the SGSN 120 sending a message comprising the position of the MS 130 to the GGSN 115, c.f. message 6ca.

FIG. 6d is a signaling diagram illustrating other exemplifying messages that may be transmitted and/or received by nodes implementing at least some embodiments of the present solution in connection with a Notification of the location information change.

FIG. 6d shows the UE 130, RAN mentioned above with reference to FIGS. 6a and 6b, the SGSN 120 and the GGSN 115 as previously describe for example with reference to FIG. 1.

The signalling diagram of FIG. 6d illustrates various action performed by and messages sent between the nodes 130, 129, 120 and 115 as will be elaborated in some detail below.

Message 1d: If the CGI or location of the UE 130 changes, the SGSN 120 receives the CGI information Update or Location Report message from the RAN. Message 1d may be seen as one way of obtaining initial position or current position as explained when discussing operation 40a and operation 42 respectively discussed above with reference to FIG. 4a.

It is preferred that the SGSN 120 is configured to detect that the location information, and thus the location of the UE 130, has changed such that the UE 130 is outside the boundary area indicated by the boundary information held by the SGSN 120, e.g. by comparing with the SGSN stored location boundary list.

Message 2d: If the SGSN 120 has been requested to report the location information to the GGSN 115 for the UE 130, the SGSN 120 shall send the Change Notification message to the GGSN 115 indicating the new location when the UE 130 is outside the current boundary area.

Message 3d: The GGSN 115 sends a Change Notification Ack message to the SGSN 120. It is preferred that this message 3d comprises Boundary Information.

Message 1d may be seen as one way of obtaining the initial position information and/or the current position information as indicated in operation 40a and 42 respectively.

Message 3d may be seen as one way of receiving the Boundary Information as indicated in operation 40b discussed above with reference to FIG. 4a.

Some embodiments described herein may be summarized in the following manner:

One embodiment is directed to a method in a serving node for reducing signaling caused by changes of location of a radio terminal. The serving node is configured to be operatively comprised by a wireless communication system, and to operatively handle payload data for the radio terminal, and to operatively communicate with a gateway node. It is preferred that the gateway node is configured to operatively act as an interface between the wireless communication system and an external network. The gateway node may comprise a Policy and Charging Enforcement Function (PCEF). The serving node may be configured to operatively act as an interface between a core network and a radio access network of the wireless communication system.

It is preferred that the method comprises the actions of:
obtaining initial position information indicating an initial position for the radio terminal,
obtaining boundary information based on the initial position information, which boundary information indicates a boundary area wherein at least one of a policy or a charging rule is to be applied for the radio terminal,
obtaining current position information indicating the current position of the radio terminal,
determining whether the radio terminal is inside or outside the boundary area based on the boundary information and the position information,
providing mobility information, indicating the current position of the radio terminal, to the gateway node when the radio terminal is outside the boundary area and not providing mobility information to the gateway node when the radio terminal is inside the boundary area.

The boundary information may be obtained by:
sending a request message to the gateway node and/or a SACC node of the system (100, 200) indicating that boundary information is requested, and
receiving a response message (4ab, 6cb) from the gateway node and/or the SACC node, which response message comprises the boundary information.

The boundary information may be obtained by:
sending a notification message to the gateway node and/or a SACC node of the wireless communication system indicating that boundary information is requested,
receiving an acknowledge message from the gateway node and/or the SACC node, which acknowledge message comprises the boundary information.

The message sent to the gateway node and/or to the SACC node comprises the initial position information indicating the initial position of the radio terminal.

Whether the radio terminal is inside or outside the boundary area may be determined by comparing the boundary information with the position information.

The mobility information may be providing in a message sent to the gateway node.

Another second boundary information may be obtained based on the current position information, which other boundary information indicates another boundary area wherein at least one of another policy or another charging rule is to be applied for the radio terminal.

Some other embodiments described herein may be summarized in the following manner:

One embodiment may be directed to a serving node configured to be operatively comprised by a wireless communication system, and to handle payload data for a radio terminal, and to operatively communicate with a gateway node. It is preferred that the gateway node is configured to operatively act as an interface between the wireless communication system and an external network. The gateway node may comprise a Policy and Charging Enforcement Function (PCEF). The serving node may be configured to operatively act as an interface between a core network and a radio access network of the wireless communication system.

It is preferred that the serving node is further configured to operatively:
obtain initial position information indicating an initial position for the radio terminal,
obtain boundary information based on the initial position information, which boundary information indicates a boundary area wherein at least one of a policy or a charging rule is to be applied for the radio terminal,
obtain current position information indicating the current position of the radio terminal,
determine whether the radio terminal is inside or outside the boundary area based on the boundary information and the position information,
provide mobility information, indicating the current position of the radio terminal, to the gateway node when the radio terminal is outside the boundary area, and not provide mobility information to the gateway node when the radio terminal is inside the boundary area to reduce signaling caused by change of location of the radio terminal.

The serving node may be configured to operatively:
send a request message to the gateway node and/or the SACC node of the system indicating that boundary information is requested, and
receive a response message from the gateway node and/or the SACC node, which response message comprises the boundary information.

The serving node may be configured to operatively:
send a notification message to the gateway node and/or a SACC node of the wireless communication system indicating that boundary information is requested,
receive an acknowledge message from the gateway node and/or the SACC node, which acknowledge message comprises the boundary information.

The serving node may be configured to operatively include the initial position information indicating the initial position of the radio terminal in the message sent to the gateway node and/or to the SACC node.

The serving node may be configured to determine whether the radio terminal is inside or outside the boundary area by comparing the boundary information with the position information.

The serving node may be configured to operatively provide the mobility information in a message sent to the gateway node.

The mobility management node may be configured to operatively obtain another second boundary information based on the current position information, which other boundary information indicates another boundary area wherein at least one of another policy or another charging rule is to be applied for the radio terminal.

The example embodiments presented herein are not limited to LTE, but may apply in any RAN, single- or multi-RAT. Some other RAT examples are LTE-Advanced, UMTS, HSPA, 10 GSM, cdma2000, HRPD, WiMAX, and WiFi or similar. The foregoing description of the example embodiments have been presented for purposes of illustration and description.

The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that any of the example embodiments presented herein may be used in conjunction, or in any combination, with one another.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the example embodiments, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, and executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

### ABBREVIATIONS

S1-MME: Reference point for the control plane protocol between E-UTRAN and MME.

S1-U: Reference point between E-UTRAN and Serving GW for the per bearer user plane tunnelling and inter eNodeB path switching during handover.

S3: It enables user and bearer information exchange for inter 3GPP access network mobility in idle and/or active state.

S4: It provides related control and mobility support between GPRS Core and the 3GPP Anchor function of Serving GW. In addition, if Direct Tunnel is not established, it provides the user plane tunnelling.

S5: It provides user plane tunnelling and tunnel management between Serving GW and PDN GW. It is used for Serving GW relocation due to UE mobility and if the Serving GW needs to connect to a non-collocated PDN GW for the required PDN connectivity.

S6a: It enables transfer of subscription and authentication data for authenticating/authorizing user access to the evolved system (AAA interface) between MME and HSS.

Gx: It provides transfer of (QoS) policy and charging rules from PCRF to Policy and Charging Enforcement Function (PCEF) in the PDN GW.

S8: Inter-PLMN reference point providing user and control plane between the Serving GW in the VPLMN and the PDN GW in the HPLMN. S8 is the inter PLMN variant of S5.

S9: It provides transfer of (QoS) policy and charging control information between the Home PCRF and the Visited PCRF in order to support local breakout function.

S10: Reference point between MMEs for MME relocation and MME to MME information transfer.

S11: Reference point between MME and Serving GW.

S12: Reference point between UTRAN and Serving GW for user plane tunnelling when Direct Tunnel is established. It is based on the Iu-u/Gn-u reference point using the GTP-U protocol as defined between SGSN and UTRAN or respectively between SGSN and GGSN. Usage of S12 is an operator configuration option.

S13: It enables UE identity check procedure between MME and EIR.

SGi: It is the reference point between the PDN GW and the packet data network. Packet data network may be an operator external public or private packet data network or an intra operator packet data network, e.g. for provision of IMS services. This reference point corresponds to Gi for 3GPP accesses.

Rx: The Rx reference point resides between the AF and the PCRF in the TS 23.203 [6].

AF Application Function

AN Access Network

ARP Allocation and Retention Priority

AMBR Aggregate Maximum Bit Rate

ANDSF Access Network Discovery and Selection Function

BBERF Bearer Binding and Event Reporting Function

BSC Base Station Controller

BSS Base Station System

BSSGP Base Station System GPRS Protocol

CBC Cell Broadcast Centre

CBE Cell Broadcast Entity

CCoA Collocated Care-of-address

CGI Cell Global Identifier

CN Core Network

CSG Closed Subscriber Group

CSG ID Closed Subscriber Group Identity

DL TFT Down Link Traffic Flow Template

DSMIPv6 Dual-Stack MIPv6

eAN enhanced AN

ECGI E-UTRAN Cell Global Identifier

ECM EPS Connection Management

ECN Explicit Congestion Notification

eGTP enhanced Gateway Tunnelling Protocol

eNodeB enhanced Node B

EMM EPS Mobility Management

EPC Evolved Packet Core

EPS Evolved Packet System

ePDG Evolved Packet Data Gateway

E-RAB E-UTRAN Radio Access Bearer

E-UTRAN Evolved Universal Terrestrial Radio Access Network

FACoA Foreign Agent Care-of-Address

GBR Guaranteed Bit Rate

GGSN Gateway GPRS Support Node

GPRS General Packet Radio Service

GRE Generic Routing Encapsulation

GSM Global Communications System

GTP GPRS Tunneling Protocoll

GTP-C GTP control

GTP-U GTP user data tunneling

GUMMEI Globally Unique MME Identifier

GUTI Globally Unique Temporary Identity

GW Gateway

H ANDSF Home-ANDSF

HeNB Home eNode B

HeNB GW Home eNode B Gateway

HFN Hyper Frame Number

HO Hand Over

HRPD High Rate Packet Data

HSS Home Subscriber Server

HSGW HRPD Serving GateWay

IE Information Element

IETF Internet Engineering Task Force

IMSI International Mobile Station Identity

IFOM IP Flow Mobility

IP Internet Protocol

IPMS IP Mobility management Selection

ISR Idle mode Signalling Reduction

LBI Linked EPS Bearer Id

L-GW Local GateWay

LI PA Local IP Access

LMA Local Mobility Anchor

LTE Long Term Evolution

MAG Mobile Access Gateway

MAPCON Multi Access PDN Connectivity

MBR Maximum Bit Rate

MIB Minimum Bit Rate

MIPv4 Mobile IP version 4

MIPv6 Mobile IP version 6

MME Mobility Management Entity

MMEC MME Code

MTC Machine-Type Communications

M-TMSI M-Temporary Mobile Subscriber Identity

OFCS Offline Charging System

OMC-ID Operation and Maintenance Centre Identity

PCC Policy Control and Charging

PCF Packet Control Function

PCEF Policy and Charging Enforcement Function

PCRF Policy and Charging Rules Function

PDN Packet data Network

PDP Packet Data Protocol

PGW PDN Gateway

PDCP Packet Data Convergence Protocol

PMIP Proxy Mobile IP

PMIPv6 Proxy Mobile IP version 6

PSAP Public Safety Answering Point

PTI Procedure Transaction Id

QCI QoS Class Identifier

QoS Quality of Service

OCS Online Charging Systems

QSUP QoS based on Service information in User Plane protocol

RAI Routing Area Identifier

RAN Radio Access Network

RFSP RAT/Frequency Selection Priority

RNAP Radio Access Network Application Part

RNC Radio Network Controller

SACC Service Aware Charging and Control

SAI Service Area Identifier

SGSN Serving GPRS Support Node

SGW Serving Gateway

SectorID Sector Address Identifier

S-TMSI S-Temporary Mobile Subscriber Identity

SDF Service Data Flow

SI Service Identification

SIPTO Selected IP Traffic Offload

TAC Tracking Area Code

TAD Traffic Aggregate Description

TAI Tracking Area Identity

TAU Tracking Area Update

TDF Traffic Detection Function

TEID Tunnel End Point Identifier

TI Transaction Identifier

TIN Temporary Identity used in Next update

TDF Traffic Detection Function

UE User Equipment

UDP User Datagram Protocol

UMTS Universal Mobile Telecommunications System

URRP-MME UE Reachability Request Parameter for MME

UL TFT UpLink Traffic Flow Template

ULR-Flags Update Location Request Flags

V ANDSF Visited-ANDSF

VS Vendor Specific

1. A method performed by a serving node for reducing signalling caused by changes of location of a radio terminal, the serving node is configured to be included in a wireless communication system, and further configured to handle payload data for the radio terminal, and to communicate with a gateway node acting as an interface between the wireless communication system and an external network, wherein the method comprises:
obtaining initial position information indicating an initial position of the radio terminal;
obtaining boundary information based on the initial position information, wherein the boundary information indicates a boundary area, wherein at least one of a policy or a charging rule is to be applied for the radio terminal;
obtaining current position information indicating the current position of the radio terminal;
determining whether the radio terminal is inside or outside the boundary area based on the boundary information and the current position information, wherein
the serving node is configured such that
(i) in response to determining that the radio terminal is outside the boundary area, the serving node provides mobility information indicating the current position of the radio terminal to the gateway node, and
(ii) in response to determining that the radio terminal is inside the boundary area, the serving node does not provide the mobility information to the gateway node.

2. The method according to claim 1, wherein the boundary information is obtained by:
sending a request message to the gateway node and/or a SACC node of the system indicating that boundary information is requested, and
receiving a response message from the gateway node and/or the SACC node, wherein the response message comprises the boundary information.

3. The method according to claim 1, wherein the boundary information is obtained by:
sending a notification message to a gateway node and/or a SACC node of the system indicating that boundary information is requested,
receiving an acknowledge message from the gateway node and/or the SACC node, wherein the acknowledge message comprises the boundary information.

4. The method according to claim 2, wherein the message sent to the gateway node and/or to the SACC node comprises the initial position information indicating the initial position of the radio terminal.

5. The method according to claim 1, comprising the actions of determining whether the radio terminal is inside or outside the boundary area by comparing the boundary information with the position information.

6. The method according to claim 1, comprising the actions of providing the mobility information in a message sent to the gateway node.

7. The method according to claim 1, further comprising:
obtaining another boundary information based on the current position information, wherein the other boundary information indicates another boundary area, wherein at least one of another policy or another charging rule is applied for the radio terminal.

8. A serving node configured to be included in a wireless communication system, and further configured to handle payload data for a radio terminal, and to communicate with a gateway node acting as an interface between the wireless communication system and an external network, wherein the serving node is further configured to:
obtain initial position information indicating an initial position of the radio terminal,
obtain boundary information based on the initial position information, wherein the boundary information indicates a boundary area wherein at least one of a policy or a charging rule is to be applied for the radio terminal,
obtain current position information indicating the current position of the radio terminal, and
determine whether the radio terminal is inside or outside the boundary area based on the boundary information and the current position information, wherein
the serving node is configured such that
(i) in response to determining that the radio terminal is outside the boundary area, the serving node provides mobility information indicating the current position of the radio terminal to the gateway node, and
(ii) in response to determining that the radio terminal is inside the boundary area, the serving node does not provide the mobility information to the gateway node.

9. The serving node according to claim 8, wherein the serving node is further configured to:
send a request message to the gateway node and/or a SACC node of the system indicating that boundary information is requested, and
receive a response message from the gateway node and/or the SACC node, wherein the response message comprises the boundary information.

10. The serving node according to claim 8, wherein the serving node is further configured to:
send a notification message to the gateway node and/or a SACC node of the system indicating that boundary information is requested,
receive an acknowledge message from the gateway node and/or the SACC node, which acknowledge message comprises the boundary information.

11. The serving node according to claim 9, wherein the serving node is further configured to include the initial position information indicating the initial position of the radio terminal in the message sent to the gateway node and/or to the SACC node.

12. The serving node according to claim 8, wherein the serving node is further configured to: determine whether the radio terminal is inside or outside the boundary area by comparing the boundary information with the position information.

13. The serving node according to claim 8, wherein the serving node is further configured to provide the mobility information in a message sent to the gateway node.

14. The mobility management node according to claim 8, wherein the mobility management node is further configured to: obtain another boundary information based on the current position information, wherein the other boundary information indicates another boundary area wherein at least one of another policy or another charging rule is to be applied for the radio terminal.
